(19) United States
(12) Patent Application Publication
(10) Pub. No.: US 2002/0112335 A1
(43) Pub. Date: Aug. 22, 2002

(54) Method of manufacturing vibrating gyroscope

(75) Inventors: Kazuhiro Ebara, Shiga-ken (JP); Masato Koike, Toyama-ken (JP)

Correspondence Address: OSTROLENK FABER GERB & SOFFEN, 1180 AVENUE OF THE AMERICAS, NEW YORK, NY, 100368403

(73) Assignee: Murata Manufacturing Co., Ltd.

(21) Appl. No.: 10/058,680

(22) Filed: Jan. 29, 2002

(30) Foreign Application Priority Data
Jan. 29, 2001 (JP) 2001-020147

(51) Int. Cl. H04R 17/00; B23P 17/00

(52) U.S. Cl. 29/423; 29/25.35

(57) ABSTRACT

A vibrating gyroscope production method in which, in order to produce a vibrating gyroscope, a vibrator, a supporting member, and an enclosure are formed. A support and a positioning member are integrally formed with the enclosure. The vibrator is positioned with respect to the enclosure by the positioning member. With the vibrator being positioned with respect to the enclosure by the positioning member, the vibrator is supported by the support through the supporting member. Thereafter, the positioning member is removed from the enclosure. The invention makes it possible to produce a vibrating gyroscope whose vibrator is precisely positioned with respect to the enclosure and which can precisely detect angular speed.

### BACKGROUND OF THE INVENTION

1. Field of the Invention

The present invention relates to a method of manufacturing a vibrating gyroscope, and, more particularly, to a method of manufacturing a vibrating gyroscope which is applied to, for example, a system which detects movement of a movable body by detecting, for example, rotational angular speed, a navigation system which properly guides a movable body by detecting the position of the movable body, or a vibration absorbing device such as a hand swing controlling device which properly absorbs vibration by detecting rotational angular speed caused by external vibration, such as vibration produced when a hand swings.

2. Description of the Related Art

A vibrator supporting structure used in a related vibrating gyroscope, which is a background art of the present invention, is disclosed in, for example, Japanese Unexamined Utility Model Application Publication Nos. 6-4616 and 6-22920. In these related arts, the ease with which the vibrating gyroscope is assembled is enhanced by providing as a supporting tool for supporting the vibrator a holding portion for holding both ends of the vibrator.

However, in the above-described related arts, the supporting tool and an enclosure of the vibrating gyroscope are separate parts, so that clearance provided at and dimensional precision of the enclosure, the supporting tool, the vibrator, and jigs used to assemble these are required, thereby resulting in the problem of reduced precision with which the supporting tool is positioned with respect to the enclosure, and, thus, the problem of reduced precision with which the vibrator is positioned with respect to the enclosure.

More specifically, the vibrating gyroscope is installed with reference to the external shape of the enclosure so that a detection axis of the vibrator becomes parallel to an axis where detection of angular speed is desired. However, in the above-described related arts, since the precision with which the vibrator is positioned with respect to the enclosure is poor, deviation between the axis where detection of angular speed is desired and the detection axis of the vibrator often occurs. In this case, the efficiency with which the angular speed is detected is reduced in proportion to cos θ (θ angle of deviation between the axis where detection of angular speed is desired and the detection axis of the vibrator), so that the angular speed cannot be precisely detected.

### SUMMARY OF THE INVENTION

Accordingly, it is a primary object of the present invention to provide a vibrating gyroscope production method which makes it possible to precisely position a vibrator with respect to an enclosure and to precisely detect angular speed.

To this end, according to the present invention, there is provided a method of manufacturing a vibrating gyroscope including a vibrator and an enclosure having a support for supporting the vibrator formed thereon. The method comprises the steps of integrally forming a positioning member with the enclosure, the positioning member being used to determine a position of the vibrator with respect to the enclosure; and supporting the vibrator by the support while the vibrator is positioned with respect to the enclosure by the positioning member.

The method of manufacturing a vibrating gyroscope of the present invention may further comprise the step of removing the positioning member from the enclosure after the step of supporting the vibrator by the support.

When either the structure of the basic form or the structure using the structure of the basic form is used, the vibrator may be supported by the support through a supporting member.

In such a method of manufacturing a vibrating gyroscope according to the present invention, the vibrator is supported by a support while the vibrator is positioned with respect to the enclosure by a positioning member which is integrally formed with the enclosure. Therefore, in the vibrating gyroscope produced by the vibrating gyroscope production method in accordance with the present invention, the precision with which the vibrator is positioned with respect to the enclosure is increased. Consequently, when the vibrating gyroscope is installed with reference to the external shape of the enclosure, deviation between an axis where detection of angular speed is desired and a detection axis of the vibrator hardly occurs, so that angular speed can be precisely detected. When, after the vibrator has been supported by the support, the positioning member is removed from the enclosure, the positioning member will not get in the way.

The above-described object, other objects, and features and advantages of the present invention will become clearer from a detailed description of an embodiment of the present invention below with reference to the drawings.

### BRIEF DESCRIPTION OF THE DRAWINGS

FIG. 1 is a plan view diagrammatically showing a vibrating gyroscope which is produced by a vibrating gyroscope production method of the present invention.

FIG. 2 is a perspective view of a vibrator used in the vibrating gyroscope shown in FIG. 1.

FIG. 3 is a perspective view illustrating steps of manufacturing the vibrating gyroscope shown in FIG. 1.

FIG. 4 is a plan view diagrammatically illustrating steps of manufacturing the vibrating gyroscope shown in FIG. 1.

### DESCRIPTION OF THE PREFERRED EMBODIMENT

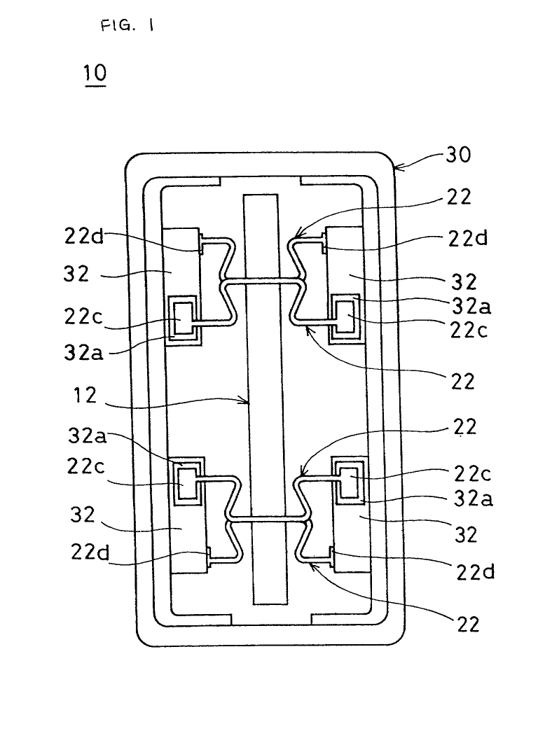

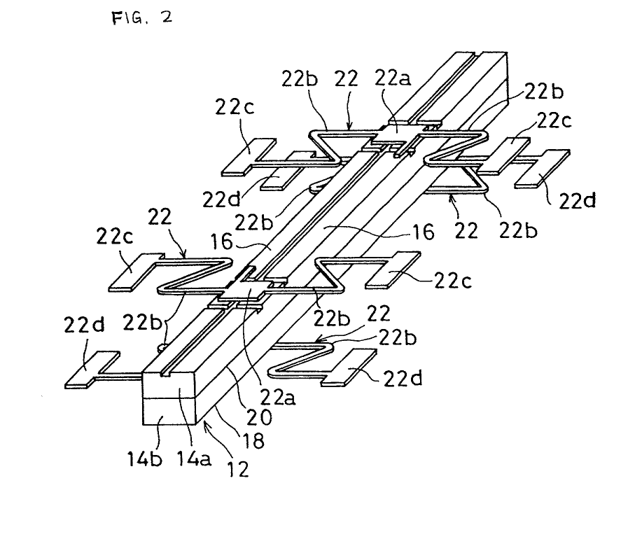

FIG. 1 is a plan view diagrammatically showing a vibrating gyroscope which is produced by a vibrating gyroscope production method of the present invention. FIG. 2 is a perspective view of a vibrator used in the vibrating gyroscope. A vibrating gyroscope 10 shown in FIG. 1 includes a vibrator 12 which is formed into the shape of, for example, a square prism.

As shown in FIG. 2, the vibrator 12 includes, for example, a strip-shaped first piezoelectric substrate 14a and a strip-shaped second piezoelectric substrate 14b. The first piezoelectric substrate 14a and the second piezoelectric substrate 14b are placed upon each other and are bonded together. The first piezoelectric substrate 14a and the second piezoelectric substrate 14b are polarized in opposite thickness directions. The first piezoelectric substrate 14a and the second piezoelectric substrate 14b may be polarized in facing directions.

Two segmented electrodes 16 and 16 are formed on the principal surface of the first piezoelectric substrate 14a so as to be separated from each other in the widthwise direction thereof. A common electrode 18 is formed on the principal surface of the second piezoelectric substrate 1 4b. An intermediate electrode 20 is formed between the first piezoelectric substrate 14a and the second piezoelectric substrate 14b.

In the vibrator 12, the first piezoelectric substrate 14a and the second piezoelectric substrate 14b are polarized in opposite thickness directions, so that, when, for example, a drive signal, such as a sinusoidal signal, is applied between the two segmented electrodes 16 and 16 and the common electrode 18, the first piezoelectric substrate 14a and the second piezoelectric substrate 14b vibrate opposite each other. In this case, when the first piezoelectric substrate 14a stretches in a direction parallel to the principal surface thereof, the second piezoelectric substrate 14b contracts in a direction parallel to the principal surface thereof. In contrast, when the first piezoelectric substrate 14a contracts in a direction parallel to the principal surface thereof, the second piezoelectric substrate 14b stretches in a direction parallel to the principal surface thereof. Therefore, the first piezoelectric substrate 14a and the second piezoelectric substrate 14b bend and vibrate in directions perpendicular to their principal surfaces, with portions of these piezoelectric substrates 14a and 14b situated slightly inward from both end portions thereof in the longitudinal directions thereof serving as nodal portions.

Substantially rectangular plate shaped center portions 22a of four corresponding supporting members 22 are mounted to four corresponding locations in accordance with the corresponding nodes at the top and bottom surfaces of the vibrator 12 by using, for example, solder or an electrically conductive adhesive, so that the vibrator 12 is sandwiched from the upward and downward directions. The supporting members 22 are electrically conductive wires for providing drive signals to the segmented electrodes 16 and 16 and the common electrode 18 of the vibrator 12 and for obtaining detection signals from the segmented electrodes 16 and 16 and the common electrode 18 of the vibrator 12. Accordingly, the center portion 22a of one of the supporting members 22 in the longitudinal direction thereof on the top surface of the vibrator 12 is electrically connected to one of the segmented electrodes 16, while the center portion 22a of the other supporting member 22 in the longitudinal direction thereof on the top surface of the vibrator 12 is electrically connected to the other segmented electrode 16. The center portions 22a of the two supporting members 22 on the bottom surface of the vibrator 12 are electrically connected to the common electrode 18.

The center portions 22a of the above-described supporting members 22 are formed as substantially rectangular plate shaped pads. Through corresponding substantially Z-shaped intermediate portions 22b used for obtaining a vibrator- 12 vibration confinement effect, rectangular plate shaped end portions 22c are formed, one on each side of each center portion 22a of its corresponding top supporting member 22, and rectangular plate shaped end portions 22d are formed, one on each side of each center portion 22a of its corresponding bottom supporting member 22. These supporting members 22 are formed by punching out, for example, a permanently elastic metal plate material, such as phosphor bronze.

Further, this vibrating gyroscope 10 includes a box-shaped enclosure 30 formed of, for example, synthetic resin. Four rectangular parallelepiped supports 32 having electrodes 32a for transmitting signals from, for example, the vibrator 12 are provided, two on each inside wall in the widthwise direction of the enclosure 30, so as to be integrally formed with the enclosure 30 and so as to be separated from each other.

The four end portions 22d of the two supporting members 22 mounted to the bottom surface of the vibrator 12 are integrally molded to the enclosure 30 by insert molding and are mounted thereto. The four end portions 22c of the two supporting members 22 mounted to the top surface of the vibrator 12 are mounted to the electrodes 32a on the top surface of the four supports 32 provided on the enclosure 30 by using, for example, solder or an electrically conductive adhesive.

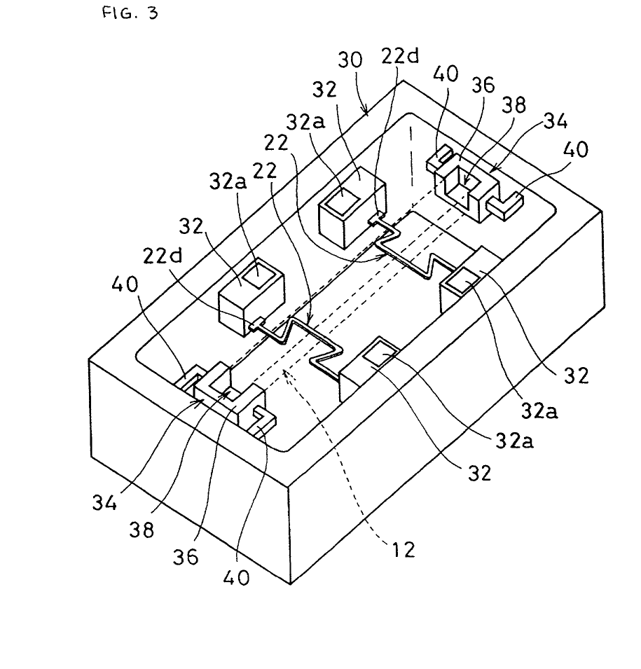

In order to produce this vibrating gyroscope 10, the vibrator 12, the supporting members 22, and the enclosure 30 are formed. In this case, as shown in FIG. 3, in addition to the four supports 32, two positioning members 34 are provided, one on each inner wall in the longitudinal direction of the enclosure 30, so as to be integrally formed with the enclosure 30. The positioning members 34 are provided for positioning the vibrator 12 with respect to the enclosure 30. Each positioning member 34 includes a block-shaped holding portion 36. A recess 38 is formed in each holding portion 36 in correspondence with its corresponding end portion of the vibrator 12. Each holding portion 36 is connected to the enclosure 30 through, for example, two thin L-shaped legs 40.

The four end portions 22d of the two bottom supporting members 22 are integrally formed with the four supports 32, provided on the housing 30, by insert molding and are mounted thereto.

As shown by dotted lines in FIG. 3, each end portion of the vibrator 12 is fitted to its corresponding recess 38 of each of the two positioning members 34 provided on the enclosure 30. This fitting operation positions the vibrator 12 with respect to the enclosure 30.

Accordingly, with the vibrator 12 being positioned with respect to the enclosure 30, the two supporting members 22 mounted to their corresponding supports 32 are mounted to the bottom surface of the vibrator 12 by using, for example, solder or an electrically conductive adhesive.

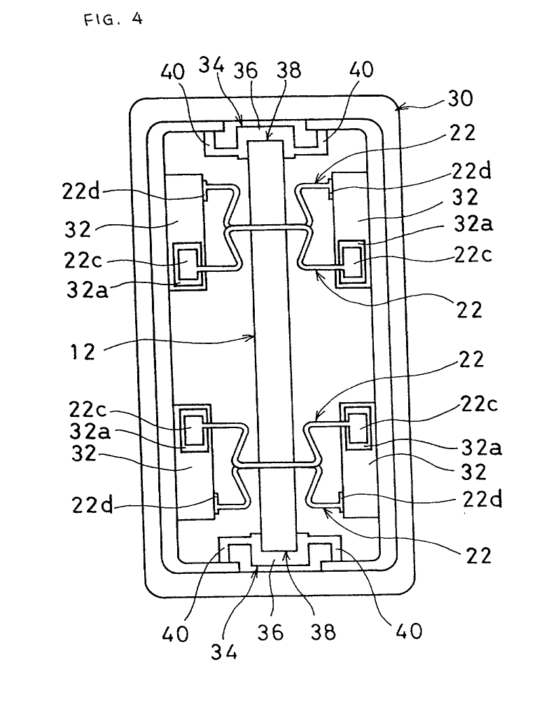

As shown in FIG. 4, with the vibrator 12 being positioned with respect to the enclosure 30, the two other supporting members 22 are mounted to the top surface of the vibrator 12 and the top surfaces of the four supports 32.

In order to prevent the positioning members 34 from inhibiting driving of the vibrator 12 and detection from the vibrator 12, the two positioning members 34 are removed by cutting the base portions of the four legs 40, so that the vibrating gyroscope 10 shown in FIG. 1 is produced.

In the above-described method of manufacturing the vibrating gyroscope 10, the vibrator 12 is supported by the supports 32 while it is positioned with respect to the enclosure 30 by the positioning members 34 that are integrally formed with the enclosure 30. Therefore, in the vibrating gyroscope 10, the precision with which the vibrator 12 is positioned with respect to the enclosure 30 is increased. Therefore, when the vibrating gyroscope 10 is installed with reference to the external shape of the enclosure 30, deviation between an axis where detection of angular speed is desired and a detection axis (center axis) of the vibrator 12 hardly occurs, so that the angular speed can be detected precisely.

In the above-described method of manufacturing the vibrating gyroscope 10, the supports 32 are integrally formed with the enclosure 30, so that the step of mounting the supports 32 to the enclosure 30 is not required, the precision with which the vibrator 12 is mounted to the supports 32 is increased in order to stabilize the characteristics of the vibrator 12, and the number of component parts used can be reduced, so that a low-cost vibrating gyroscope can be obtained.

In the above-described method of manufacturing the vibrating gyroscope 10, the vibrating gyroscope 10 is easily assembled, jigs and the like are not required during the assembly operation, and the assembly precision is good. In this case, when the enclosure 30, the supports 32, and the positioning members 34 of the vibrating gyroscope 10 are formed by molding them out of resin, the molding precision is high at, for example, ±50 μm or less.

In contrast to this, when a vibrating gyroscope is assembled by separately forming an enclosure and supports and by using a jig, the molding precision of the enclosure of ±50 μm, the jig precision of ±50 μm, the clearance provided at the enclosure and the jig of ±50 μm, the molding precision of the supports of ±50 μm, the clearance provided at the supports and the jig of ±50 μm, etc., accumulate, so that the precision with which a vibrator is positioned with respect to the enclosure is reduced.

Even if portions which hold the supports are provided at the enclosure, dimensional errors occur in each of the portions, thereby requiring clearance, so that assembly positional precision comparable to that of the invention of the application cannot be obtained.

In the above-described vibrating gyroscope 10, the vibrator 12 having the shape of a square prism, the supporting members 22 having substantially z-shaped intermediate portions 22b, the supports 32 having rectangular parallelepiped shapes, and the positioning members 34 having particular shapes are used. However, in the present invention, these component parts may have other shapes.

According to the present invention, it is possible to produce a vibrating gyroscope whose vibrator is precisely positioned with respect to an enclosure and which makes it possible to precisely detect angular speed.

What is claimed is:

1. A method of manufacturing a vibrating gyroscope including a vibrator and an enclosure having a support for supporting the vibrator formed thereon, the method comprising the steps of:
integrally forming a positioning member with the enclosure, said positioning member being used to determine a position of the vibrator with respect to the enclosure; and
supporting the vibrator by the support while the vibrator is positioned with respect to the enclosure by the positioning member.

2. A method of manufacturing a vibrating gyroscope according to claim 1, further comprising the step of removing the positioning member from the enclosure after the step of supporting the vibrator by the support.

3. A method of manufacturing a vibrating gyroscope according to either claim 1 or claim 2, wherein the vibrator is supported by the support through a supporting member.
